(19) United States
(12) Patent Application Publication
(10) Pub. No.: US 2006/0221377 A1
(43) Pub. Date: Oct. 5, 2006

(54) Image forming apparatus

(75) Inventor: Ken Nishio, Osaka (JP)

Correspondence Address: SMITH, GAMBRELL & RUSSELL, 1850 M STREET, N.W., SUITE 800, WASHINGTON, DC, 20036, US

(73) Assignee: KYOCERA MITA CORPORATION

(21) Appl. No.: 11/391,336

(22) Filed: Mar. 29, 2006

(30) Foreign Application Priority Data
Mar. 31, 2005 (JP) 2005-100559

(51) Int. Cl. G06K 15/00

(52) U.S. Cl. 358/1.14; 358/1.15; 358/402

(57) ABSTRACT

An image forming apparatus has a storage section that stores image data, a display section that displays the image data stored in the storage section, a transmission section that extracts from the storage section the image data stored therein and then transmits the image data, and a control section that, when a transmission error occurs while the transmission section is transmitting the image data and the transmission section can no longer transmit the image data, stores in the storage section the image data left untransmitted as the image data having a transmission failure record, and inhibits the output of, of the image data stored in the storage section, the image data having the transmission failure record.

This application is based on Japanese Patent Application No. 2005-100559 filed on Mar. 31, 2005, the contents of which are hereby incorporated by reference.

### BACKGROUND OF THE INVENTION

1. Field of the Invention

The present invention relates to an image forming apparatus provided with a printer function, a facsimile function, and the like, and more particularly to an image forming apparatus that can save image data whose transmission has failed due to a transmission error.

2. Description of Related Art

There have conventionally been known image forming apparatuses, such as facsimile apparatuses, that are provided with a facsimile function for transmitting image data to a specified addressee over a telephone network or the like. In such an image forming apparatus, after a user specifies the telephone number of an addressee, the image of an original document is captured to create image data. Then the created image data is temporarily stored in a memory, and the image data is then read from the memory and transmitted over a telephone network or the like to the addressee's apparatus to which the image data is addressed.

However, if the addressee's telephone line is busy or otherwise occupied, the originator's image forming apparatus cannot communicate with the addressee's apparatus, and thus a transmission error occurs. In this situation, if the image data to be transmitted to the addressee's apparatus is deleted from the memory of the originator's image forming apparatus, the originator is afterward required to capture the image of the original document again to create the image data. This diminishes the user-friendliness of the image forming apparatus. As a solution to this problem, the latest image forming apparatuses are so designed that, when a transmission error occurs, they can save untransmitted image data in a memory.

As this type of facsimile apparatus, there has been proposed a facsimile apparatus that, when a transmission error occurs, can save untransmitted image data in a memory and in addition that, to prevent the memory from becoming full with accumulated untransmitted image data, can delete the untransmitted image data stored in the memory at predetermined times (see JP-A-2000-115493).

In this facsimile apparatus, when an important document such as a confidential document is transmitted to an addressee's apparatus, if a transmission error occurs, the image data of the confidential document is stored in the memory. Then, until the image data is transmitted to the addressee's apparatus next time, or until the next predetermined time comes, the image data of the confidential document remains stored in the memory. Meanwhile, anyone can view the image data of the confidential document by accessing the memory.

However, an important document such as a confidential document should be viewable only to limited people including the one who has created it, and leaving it viewable to third persons other than those limited people is undesirable for security reasons. If the image data of a confidential document stored in the memory is viewed by a third person other than people authorized to view it, the information in the confidential document may leak outside. Even with a facsimile apparatus, such as one that requires authentication of user IDs or the like, that can be used only by people assigned authentic user IDs, a third person other than people assigned authentic user IDs can disguise him or herself as one assigned an authentic user ID to enter the user ID and view the image data of a confidential document stored in the memory. Thus, again, the information in the confidential document may leak outside.

### SUMMARY OF THE INVENTION

In view of the conventionally encountered inconveniences mentioned above, it is an object of the present invention to provide an image forming apparatus that operates with a higher degree of security by inhibiting output of untransmitted image data saved in a memory when a transmission error occurs.

To achieve the above object, according to the present invention, an image forming apparatus is provided with: a storage section that stores image data; a display section that displays the image data stored in the storage section; a transmission section that extracts from the storage section the image data stored therein and then transmits the image data; and a control section that, when a transmission error occurs while the transmission section is transmitting the image data and the transmission section can no longer transmit the image data, stores in the storage section the image data left untransmitted as the image data having a transmission failure record, and inhibits the output of, of the image data stored in the storage section, the image data having the transmission failure record.

According to the present invention, even when image data left untransmitted due to a transmission error is stored in the storage section, output of image data stored in the storage section and having a transmission error record is inhibited. Thus, it is possible to securely prevent leakage of information resulting from output of image data having a transmission error record, and thereby to enhance the degree of security provided by an image forming apparatus.

### BRIEF DESCRIPTION OF THE DRAWINGS

FIG. 1 is a diagram showing the overall configuration of an image processing system embodying the invention;

FIG. 2 is a diagram showing the configuration of an image forming apparatus used in the image processing system embodying the invention;

FIG. 3 is a diagram showing the configuration of the operation panel provided in the image forming apparatus in the image processing system embodying the invention;

FIG. 4 is a diagram showing the contents displayed on the display screen to permit the selection of a folder in the image processing system embodying the invention;

FIG. 5 is a diagram showing the contents displayed on the display screen to permit the selection of a document saved in the folder in the image processing system embodying the invention;

FIG. 6 is a diagram showing the contents displayed on the display screen to permit the selection of an image data transmission addressee in the image processing system embodying the invention;

FIG. 7 is a flow chart showing the flow of operations performed when the facsimile function of the image forming apparatus is used in the image processing system embodying the invention; and

FIG. 8 is a flow chart showing the flow of operations performed when the facsimile function of the image forming apparatus is used in the image processing system embodying the invention.

### DETAILED DESCRIPTION OF PREFERRED EMBODIMENTS

Hereinafter, an embodiment of the present invention will be described in detail with reference to the accompanying drawings. An image forming apparatus according to the present invention is used in an image processing system as described below.

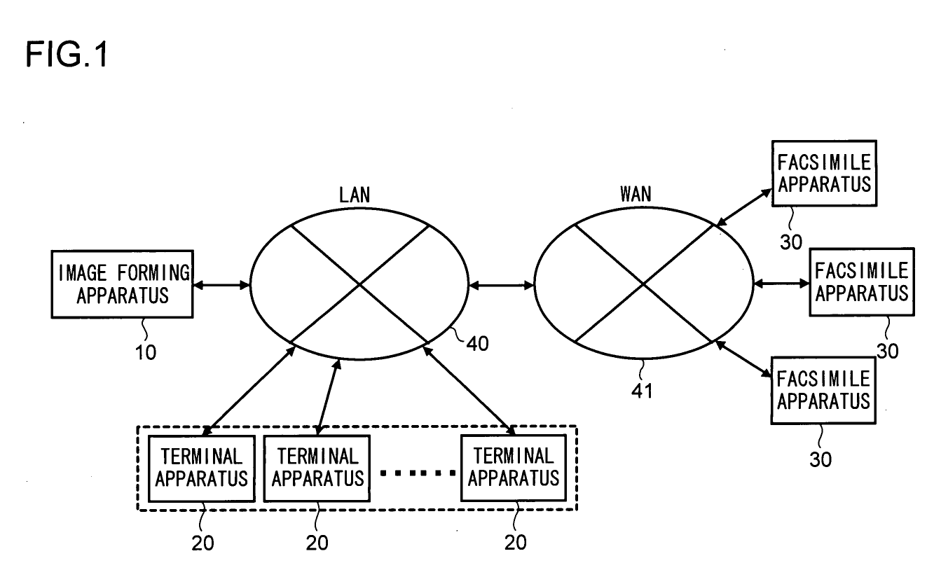

As shown in FIG. 1, an image processing system embodying the present invention is built with: an image forming apparatus 10 that forms images based on image data; a plurality of terminal apparatuses 20 that transmit and receive image data by communicating with the image forming apparatus 10; and a plurality of communication apparatuses 30 (hereinafter referred to as the “facsimile apparatuses”) that are provided with a facsimile function for receiving and outputting image data transmitted from the image forming apparatus 10 and that are each assigned a telephone number unique thereto. In this image processing system, the image forming apparatus 10 is connected to each of the terminal apparatuses 20 over a LAN 40 (local area network), and the facsimile apparatuses 30 are each connected to the LAN 40 over a WAN 41 (wide area network) such as a telephone network.

In the image processing system configured as described above, the image forming apparatus 10 is, for example, an MFP (multi-function peripheral) provided with four functions, namely a copier function, a printer function, a scanner function, and a facsimile function. In addition, the image forming apparatus 10 is further provided with a mailing function for transmitting and receiving electronic mail.

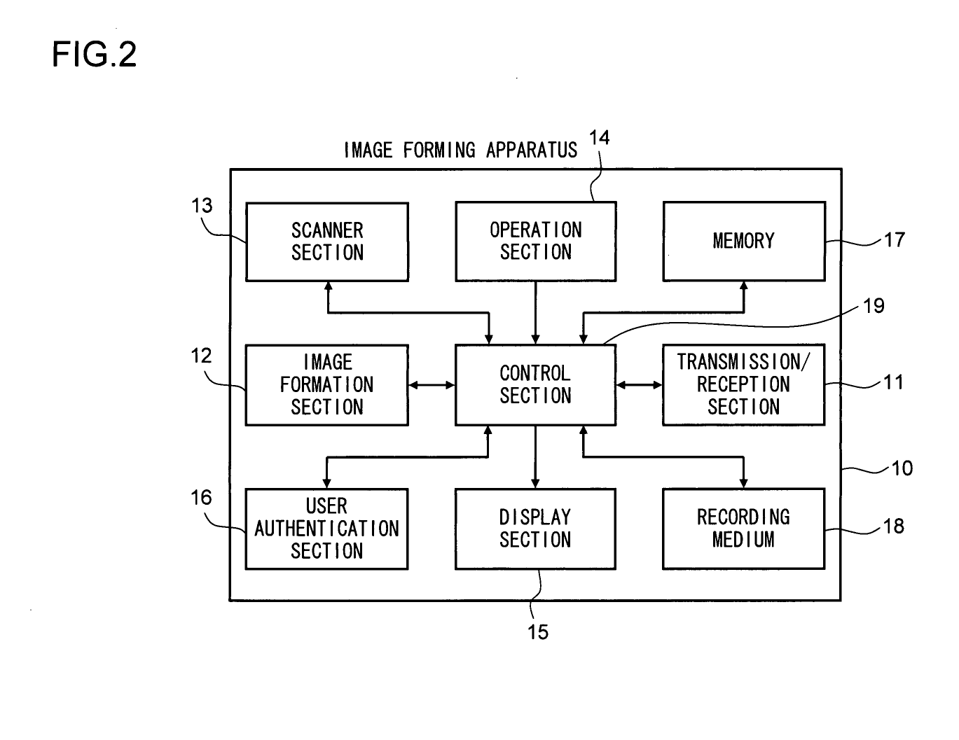

As shown in FIG. 2, the image forming apparatus 10 is provided with: a transmission/reception section 11 that is connected to the LAN 40 to transmit and receive data to and from each of the terminal apparatuses 20; an image formation section 12 that serves as a printout section by making printouts of images formed based on image data when the copier or printer function is used; a scanner section 13 that has a document feed inlet (unillustrated) and that serves as an image reading section by reading the image of an original document fed into the document feed inlet by capturing it by the scanner function when the facsimile function is used; an operation section 14 that accepts operations performed by a user of the image forming apparatus 10 to enter conditions for image formation and telephone numbers of image data transmission addressees by the facsimile function; a display section 15 that displays the conditions for image formation and the telephone numbers of the image data transmission addressees by the facsimile function as entered via the operation section 14 by a user of the image forming apparatus 10; a user authentication section 16 that, on the basis of a user ID and a password entered via the operation section 14, checks whether or not a person who is about to use the image forming apparatus 10 is one registered as an authentic user of the image forming apparatus 10; a memory 17 that temporarily stores image data to be transmitted to any of the terminal apparatuses 20 and the facsimile apparatuses 30; a recording medium 18 that has a document box in which there are provided folders allocated one for each user of the image forming apparatus 10 so as to be used as storage regions for saving image data; and a control section 19 that counts the number of times the telephone number of an image data transmission addressee is dialed when the facsimile function is used and that controls the operation of the transmission/reception section 11, the image formation section 12, the scanner section 13, the operation section 14, the display section 15, and the user authentication section 16.

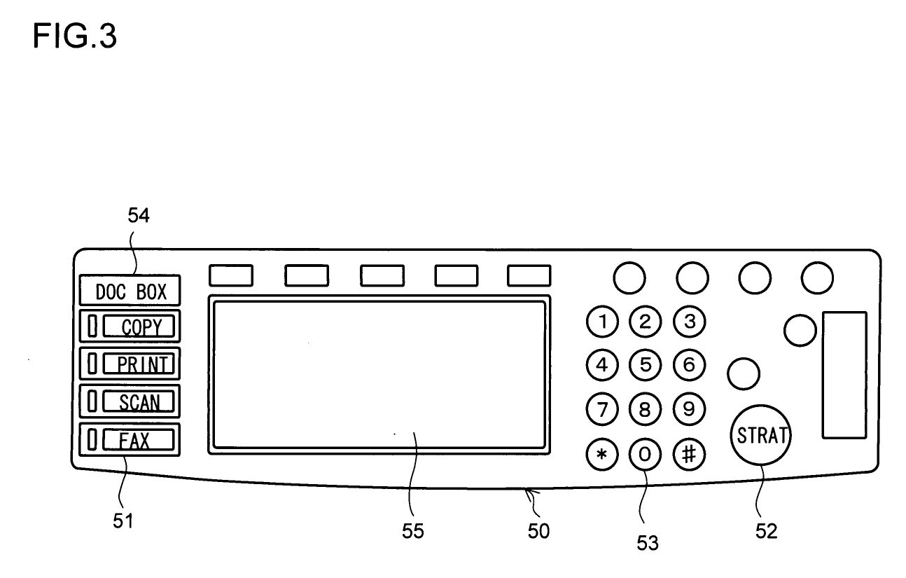

The operation section 14 of the image forming apparatus 10 is provided with an operation panel 50, as shown in FIG. 3, that is operated by a user of the image forming apparatus 10. On the operation panel 50, there are arranged: a plurality of function select keys 51 that are operated, in the operation section 14 of the image forming apparatus 10, to switch among the copier, printer, scanner, and facsimile functions; a start key 52 that is operated to start one of these functions; a plurality of numerical keys 53 that are operated to set the number of copies to be printed, to enter the telephone number of an image data transmission addressee, and for other purposes; and a document box key 54 that is operated to display the contents of the document box on the recording medium 18.

The display section 15 of the image forming apparatus 10 is provided with a touch-panel liquid crystal display screen 55 (hereinafter referred to as the “display screen”), which is arranged on the operation panel 50. As a user of the image forming apparatus 10 touches keys and buttons displayed on the display screen 55, the operation section 14 accepts instructions from the user. When the facsimile function is used, on the display screen 55, there are displayed the telephone number of an image data transmission addressee as entered via the operation section 14 by a user of the image forming apparatus 10, the information on previously registered addressees to which image data can be sent, the contents of folders provided in the document box, the contents of image data stored in those folders, etc. The contents displayed on the display screen 55 will be described in detail later with reference to the relevant drawings.

On the recording medium 18 of the image forming apparatus 10, there are stored: a document box in which there are provided folders allocated one for each user of the image forming apparatus 10; a data table that contains the correspondence between the numbers assigned to the folders and the user IDs and passwords of users of the image forming apparatus 10; the names and telephone numbers or mail addresses of locations registered as image data transmission addressees; the user IDs and passwords of people registered as users of the image forming apparatus 10; and the transmission records (the data and time of each transmission, whether the transmission has been successful or not, the user ID of the originator, the number of pages transmitted, etc.) of image data sent by the facsimile function; and other data.

In the document box stored on the recording medium 18, there are provided folders one for each user of the image forming apparatus 10. In each folder, there is stored image data created by reading the image of an original document by the scanner function or image data transmitted from any of the terminal apparatuses 20. Moreover, as described above, on the recording medium 18 is also stored a data table that contains the correspondence between the numbers assigned to folders and the user IDs and passwords of users of the image forming apparatus 10. This permits a user of the image forming apparatus 10 to manipulate only the folder that corresponds to the user ID and passwords of that user.

The control section 19 of the image forming apparatus 10 is provided with: a timer (unillustrated) that keeps the current time; and a counter (unillustrated) that counts the number of times that the telephone number of an image data transmission addressee has been dialed when the facsimile function is used. When the facsimile function is used, this timer is used to record the date and time at which image data was transmitted to an addressee, and is used also, when no communication can be established with a facsimile apparatus 30 to which to transmit image data, to count the time at the interval of which the telephone number of an image data transmission addressee is dialed periodically. This timer is also used, when a document saved in a folder in the document box is updated, to record the date and time of the updating. When the facsimile function is used, if no communication can be established with a facsimile apparatus 30 to which to transmit image data, the counter increments by one and, when the count of the counter reaches a predetermined value (for example, three), a transmission error occurs.

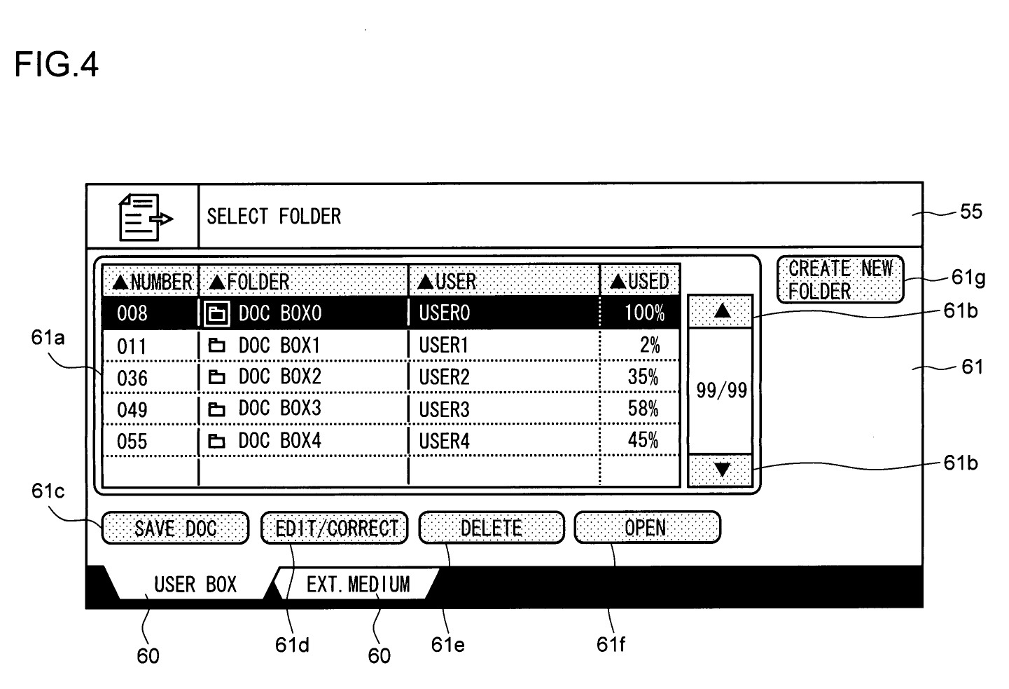

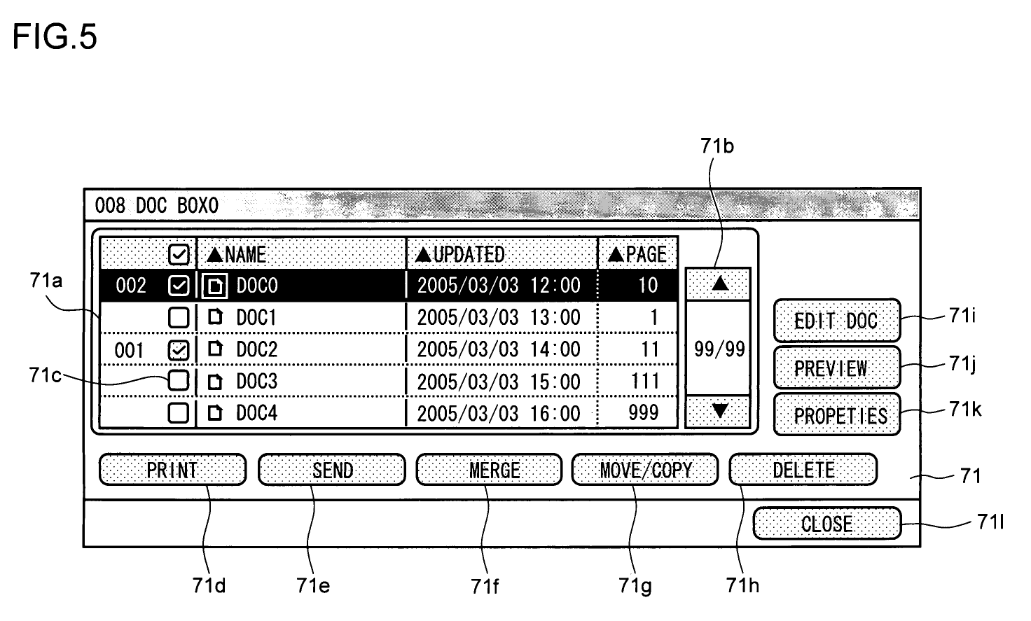

Now, with reference to FIGS. 4 and 5, a description will be given of the contents displayed on the display screen 55 of the display section 15 when the document box stored in the recording medium 18 is opened in the image forming apparatus 10 configured as described above.

To open the document box stored in the recording medium 18, a user of the image forming apparatus 10 presses the document box key 54 provided on the operation panel 50 (see FIG. 3). Then, as shown in FIG. 4, the folders provided in the document box are displayed on the display screen 55.

Specifically, in the display screen 55 shown in FIG. 4, at the bottom thereof, two tabs 60 for switching screens are displayed. When one of these tabs is touched, the display on the display screen 55 switches between a user box screen 61 that displays all the folders stored in the recording medium 18 and an external medium screen (unillustrated) that displays a medium externally connected to the image forming apparatus 10 and that permits image data stored in that medium to be captured into a folder.

When a user of the image forming apparatus 10 presses the document box key 54 provided on the operation panel 50, or when a user of the image forming apparatus 10 touches the tab 60 that displays the user box screen 61, the display on the display screen 55 switches to the user box screen 61 shown in FIG. 4.

As shown in FIG. 4, in a left part of the user box screen 61 with respect to the center thereof, a folder display column 61a is displayed in which are displayed, in separate columns, the number of each folder stored on the recording medium 18, the name of the folder, the user of the folder, and the used capacity of the folder. In this folder display column 61a, the number of each folder is determined by automatically assigning folders serial numbers in the order in which they are created. The name of each folder is determined by automatically assigning names “document box” followed by serial numbers in the order in which they are created. Users of each folder are automatically assigned names “user” followed by serial numbers in the order in which they use it. The used capacity of a folder represents what proportion of the storage capacity allocated to the folder has been occupied by documents stored therein.

Moreover, as shown in FIG. 4, on the right side of the folder display column 61a, scroll keys 61b are displayed that permit the folder display column 61a to be scrolled so that, of all the folders stored on the recording medium 18, those which are not currently displayed on the user box screen 61 are displayed thereon.

Thus, a user of the image forming apparatus 10 can, by touching the scroll keys 61b, display on the user box screen 61a folder that the user wants to select, and can then select the folder allocated to the user by touching any of the parts where the number, name, user, and used capacity of the folder are displayed in the folder display column 61a on the user box screen 61.

Moreover, as shown in FIG. 4, on the user box screen 61, under the folder display column 61a, there are displayed, from left to right: a save document key 61c for saving, in a folder allocated to a user, image data created by reading the image of an original document by the scanner function or image data stored on a medium externally connected to the image forming apparatus 10; an edit/correct key 61d for editing or correcting a number, name, or user of a folder displayed in the folder display column 61a; a delete key 61e for deleting a folder selected by a user of the image forming apparatus 10; and an open key 61f for opening a folder selected by a user of the image forming apparatus 10.

When a user of the image forming apparatus 10 selects a folder via the user box screen 61 and then touches one of the save document key 61c, the edit/correct key 61d, the delete key 61e, and the open key 61f displayed on the user box screen 61, the display on the display screen 55 switches to a screen on which are displayed a plurality of keys (unillustrated) marked with alphabetic and other characters, “A” to “Z” etc., to permit entry of a user ID and a password.

Here, as described above, on the recording medium 18, a data table is stored that contains the correspondence between the numbers assigned to folders and the user IDs and passwords of users of the image forming apparatus 10, and thus a user of the image forming apparatus 10 can manipulate only folders allocated to the user. When a user of the image forming apparatus 10 enters his or her user ID and password via the display screen 55, only if the user ID and password entered by the user coincide with the user ID and password associated with the folder selected by the user, the screen for the following steps is displayed on the display screen 55.

Moreover, as shown in FIG. 4, on the user box screen 61, on the right side of the folder display column 61a, that is, at the right-hand end of the user box screen 61, a create new folder key 61g for creating a new folder is displayed. When a user of the image forming apparatus 10 touches the create new folder key 61g displayed on the user box screen 61, a new folder is created and is displayed on the folder display column 61a. Moreover, in association with the new folder, the number thereof and the user ID and password with which the user was authenticated by the user authentication section 16 of the image forming apparatus 10 when he or she started to use the image forming apparatus 10 are stored in the recording medium 18.

When a user of the image forming apparatus 10 selects one of the folders displayed on the folder display column 61a of the user box screen 61 and then touches the open key 61f displayed on the user box screen 61, the display on the display screen 55 switches to a screen on which are displayed a plurality of keys (unillustrated) marked with alphabetic and other characters, “A” to “Z” etc., to permit entry of a user ID and a password. Subsequently, when the user enters the user ID and password corresponding to the selected folder via the display screen 55, the display on the display screen 55 switches to a screen 71 (hereinafter the “document selection screen”) that, as shown in FIG. 5, displays the documents stored in the folder selected by the user.

As shown in FIG. 5, in a left part of the document selection screen 71 with respect to the center thereof, a document display column 71a is displayed in which are displayed, in separate columns, the name of each document saved in the folder, the updating date and time thereof, and the number of pages thereof. In this document display column 71a, documents are automatically assigned names “document” followed by serial numbers in the order in which they are created. The updating date and time of a document represent the date and time at which the document was stored in the folder, the name of the document was changed, or the document was otherwise modified, and what is displayed as the updating date and time in the document display column 71a is the date and time measured by the timer provided in the control section 19.

Moreover, as shown in FIG. 5, on the right side of the document display column 71a, scroll keys 71b are displayed that permit the document display column 71a to be scrolled so that, of all the documents stored in the folder, those which are not currently displayed on the document selection screen 71 are displayed thereon.

Thus, a user of the image forming apparatus 10 can, by touching the scroll keys 71b displayed on the document selection screen 71, display on the document selection screen 71a document that the user wants to display, and can then select the document by touching any of the parts where the name, updating date and time, and number of pages of the document are displayed in the document display column 71a on the document selection screen 71.

Moreover, as shown in FIG. 5, in the document display column 71a, on the left side of the part thereof where the names of documents are shown, check boxes 71c are displayed one for each document. When a user of the image forming apparatus 10 selects more than one document, the check boxes 71c corresponding to the selected documents are checked, and the numbers indicating the order in which they are selected are displayed on the left side of the respective check boxes 71c.

Moreover, as shown in FIG. 5, on the document selection screen 71, under the document display column 71a, there are displayed, from left to right: a print key 71d for printing, by the printer function, the image data of a document selected by a user of the image forming apparatus 10; a send key 71e for transmitting, by the facsimile function, a document selected by a user of the image forming apparatus 10 to a facsimile apparatus 30; a merge key 71f for merging two or more documents selected by a user of the image forming apparatus 10 into a single document; a copy/move key 71g for making a copy of a document selected by a user of the image forming apparatus 10 or moving one to another folder; and a delete key 71h for deleting a document selected by a user of the image forming apparatus 10.

Moreover, as shown in FIG. 5, in the document selection screen 71, on the right side of the document display column 71a, three keys are displayed from top. Specifically, at the right side of the document selection screen 71, there are displayed, from top: an edit document key 71i for editing the name of a document selected by a user of the image forming apparatus 10; a preview key 71j for viewing a document selected by a user of the image forming apparatus 10; and a key 71k for showing the properties of a document selected by a user of the image forming apparatus 10, such as the size of the document and the records of transmission thereof by the facsimile function.

Furthermore, as shown in FIG. 5, in the bottom right corner of the document selection screen 71 is displayed a close key 711 for closing the document selection screen 71. When a user of the image forming apparatus 10 touches the close key 711 displayed on the document selection screen 71, the document selection screen 71 is closed so that the user box screen 61 shown in FIG. 5 is again displayed on the display screen 55. That is, the open key 61f displayed on the user box screen 61 shown in FIG. 4 corresponds to the close key 711 displayed on the document selection screen 71 shown in FIG. 5.

Now, with reference to FIGS. 4 to 6, a description will be given of the contents displayed on the display screen 55 of the display section 15 when the facsimile function is used in the image forming apparatus 10 configured as described above. It should be noted that the contents displaced on the display screen 55 differ according to whether image data created by reading the image of an original document by the scanner function is transmitted to a specified addressee or a document saved in a folder in the document box is selected to transmit the image data of the document to a specified addressee.

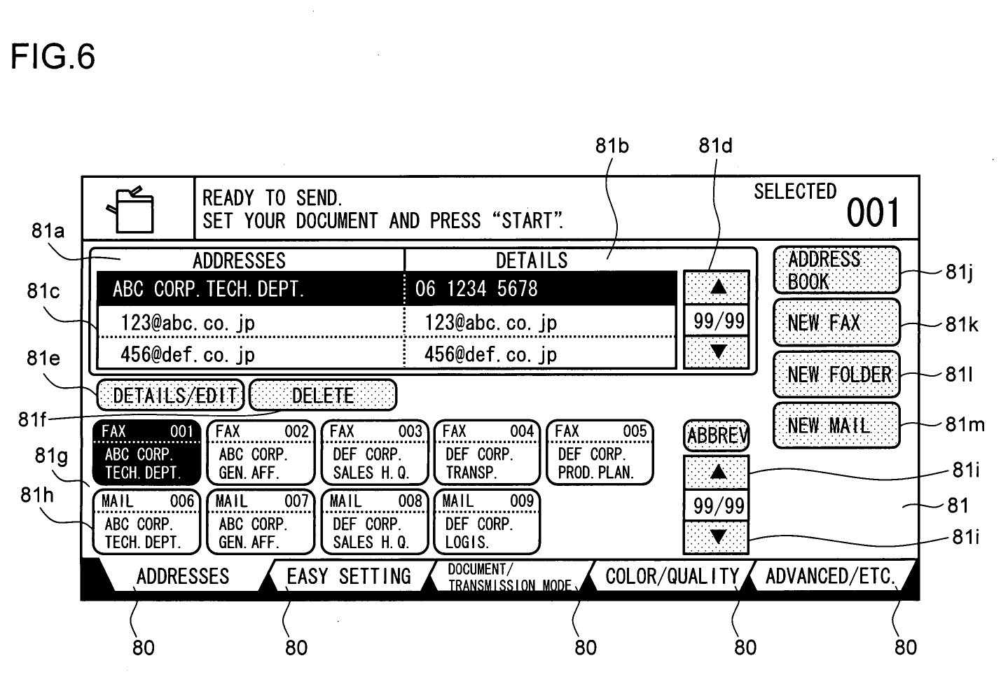

First, in a case where image data created by reading the image of an original document by the scanner function is transmitted to a specified addressee, a user of the image forming apparatus 10 presses, among the function select keys 51 provided on the operation panel 50, the one assigned to the facsimile function (see FIG. 3). This selects the facsimile function, switching the image forming apparatus 10 to the facsimile function. Now, on the display screen 55 of the operation panel 50, the contents shown in FIG. 6 are displayed.

Specifically, on the display screen 55 shown in FIG. 6, at the bottom thereof, five tabs 80 for switching screens are displayed. When one of these tabs 80 is touched, the display screen 55 is switched among the following screens: an addressee setting screen 81 for setting an image data transmission addressee; an easy setting screen (unillustrated) for setting, among all the functions with which the image forming apparatus 10 is provided, the most basic ones, such as those concerned with image density and image quality; a document/transmission mode setting screen (unillustrated) for setting the size of an original document read by the scanner function and the size of an image transmitted to the facsimile apparatus 30; a color quality setting screen (unillustrated) for setting the color type of an image (white, black, monochrome color, or full color) and the quality of an image; and an advanced/etc. setting screen (unillustrated) that displays all the functions win which the image forming apparatus 10 is provided.

When a user of the image forming apparatus 10 touches, among the function select keys 51 provided on the operation panel 50, the one assigned to the facsimile function, or when a user of the image forming apparatus 10 touches, among the tabs 80, the one that displays the addressee setting screen 81, the display screen 55 switches to the addressee setting screen 81 shown in FIG. 6.

As shown in FIG. 6, in a top left part of the addressee setting screen 81, an addressee display column 81c is displayed in which the names and the telephone numbers or mail addresses of locations registered as image data transmission addressees to which to transmit stored in the recording medium 18 are displayed in separate columns, namely an addresses column 81a and a details column 81b. In this addressee display column 81c, in the addresses column 81a are displayed the names of locations registered as image data transmission addressees, and in the details column 81b are displayed the telephone numbers or mail addresses of locations registered as image data transmission addressees. Moreover, as shown in FIG. 6, on the right side of the addressee display column 81c, scroll keys 81d are displayed that permit the addressee display column 81c to be scrolled so that image data transmission addressees that are not currently displayed on the addressee setting screen 81 is displayed thereon.

Thus, a user of the image forming apparatus 10 can, by touching the scroll keys 81d displayed on the addressee setting screen 81, display on the addressee setting screen 81 the image data transmission addressee that the user wants to select, and then can select the image data transmission addressee by touching any of the parts where the name and the telephone number or mail address of the image data transmission addressee are displayed in the addresses column 81a and the details column 81b in the addressee display column 81c on the addressee setting screen 81.

Moreover, as shown in FIG. 6, on the addressee setting screen 81, under the addressee display column 81c, there are displayed, from left to right: a details/edit key 81e for displaying and editing the details of an addressee selected by a user of the image forming apparatus 10 as an addressee to which to transit image data; and a delete key 81f for deleting an addressee selected by a user of the image forming apparatus 10 as an addressee to which to transit image data.

Moreover, as shown in FIG. 6, in a lower part of the addressee setting screen 81, an abbreviation key display column 81g is displayed in which are displayed, of the image data transmission addressees stored in the recording medium 18, those frequently used. In this abbreviation key display column 81g, a plurality of abbreviation keys 81h are displayed that each display the name of an image data transmission addressee and a mark distinguishing between a facsimile number and a mail address. Furthermore, on the addressee setting screen 81, on the right side of the abbreviation key display column 81g, scroll keys 81i are displayed that permit the abbreviation key display column 81g to be scrolled so that abbreviation keys 81h that are not currently displayed on the addressee setting screen 81 are displayed thereon.

Thus, as shown in FIG. 6, when a user of the image forming apparatus 10 touches, of the abbreviation keys 81h displayed in the abbreviation key display column 81g on the addressee setting screen 81, the abbreviation key located at top left and marked “ABC Corp. Tech. Dept.”, “ABC Corp. Tech. Dept.” is selected as an image data transmission addressee, and the color of the characters displayed on this abbreviation key 81h is inverted with the color of the background. Moreover, here, among the image data transmission addressees displayed on the addressee display column 81c, “ABC Corp. Tech. Dept.” is selected and is displayed on the addressee setting screen 81, and the color of the characters displayed in the addresses column 81a and the details column 81b is inverted with the color of the background.

Moreover, as shown in FIG. 6, on the right side of the addressee display column 81c on the addressee setting screen 81, four keys are displayed from top. Specifically, on the right side of the addressee setting screen 81, there are displayed, from top: an address book key 81j for displaying a full list of the names and the telephone numbers or mail addresses of the locations registered as image data transmission addressees to which to transmit image data stored in the recording medium 18; a new facsimile key 81k for entering the telephone number of an image data transmission addressee via the numerical keys 53 provided on the operation panel 50; a new folder key 811 for selecting a destination folder when image data is transmitted, in a form converted into the PDF format or the like, to a folder in a terminal apparatus 20 connected to the image forming apparatus 10; and a new mail key 81m for entering the mail address of an addressee when a mail message having an image attached thereto is transmitted to a terminal apparatus 20 connected to the image forming apparatus 10.

When a user of the image forming apparatus 10 touches the address book key 81j displayed on the addressee setting screen 81, the display on the display screen 55 so switches that a list of the names and the telephone numbers or mail addresses of the locations registered as image data transmission addressees is displayed on the display screen 55. When a user of the image forming apparatus 10 touches the new folder key 811 displayed on the addressee setting screen 81, the display on the display screen 55 so switches that the names of the terminal apparatuses 20 connected to the image forming apparatus 10 over the LAN 40 are, along with the folders in the terminal apparatuses 20 that are shared with the image forming apparatus 10, are displayed on the display screen 55. When a user of the image forming apparatus 10 touches the new mail key 81m displayed on the addressee setting screen 81, the display on the display screen 55 so switches that a plurality of keys (unillustrated) marked with alphabetic and other characters, “A” to “Z” etc., to permit entry of the mail address of an image data transmission addressee are displayed.

While a screen for setting an image data transmission addressee is displayed on the addressee setting screen 81 as described above, as shown in FIG. 6, at the top of the display screen 55, an indication is displayed to indicate that image data is ready to be transmitted, along with a message like “set an original document and press start key”. When a user of the image forming apparatus 10 selects an image data transmission addressee via the addressee setting screen 81, then puts an original document in the document feed inlet of the scanner section 13, and then presses the start key 52 provided on the operation panel 50, the original document is taken into the image forming apparatus 10 through the document feed inlet, and the image of the original document is read by the scanner function to create image data. The created image data is then stored in the memory 17.

Then, the telephone number of the image data transmission addressee selected via the addressee setting screen 81 by the user of the image forming apparatus 10 is dialed, and a dialing signal is transmitted to a facsimile apparatus 30 over the LAN 40 and the WAN 41 such as a telephone network. Subsequently, the image forming apparatus 10 communicates with the facsimile apparatus 30 to transmit image data stored in the memory 17 to the facsimile apparatus 30 over the LAN 40 and the WAN 41 such as a telephone network.

In a case where a document saved in a folder in the document box is selected to transmit the image data of the document to a specified addressee, a user of the image forming apparatus 10 presses the document box key 54 provided on the operation panel 50 (see FIG. 3). Then, as shown in FIG. 4, the folders provided in the document box stored on the recording medium 18 are displayed on the display screen 55, and, at the top of the display screen 55, a message like “select a folder” is displayed.

The user of the image forming apparatus 10 then selects, among the folders displayed in the folder display column 61a of the user box screen 61, a folder allocated to the user. Here, as shown in FIG. 4, if the user of the image forming apparatus 10 touches any of the parts where the number, name, user, and used capacity of, among the folders displayed in the folder display column 61a on the user box screen 61, the folder named “document box 0” are displayed, then, of the folders displayed in the folder display column 61a, the folder named “document box 0” is selected. Then, with respect to the folder named “document box 0”, the color of the characters displayed in the parts where the number, name, user, and used capacity of the folder are displayed are inverted with the color of the background.

Subsequently, when the user of the image forming apparatus 10 selects, among the folders displayed in the folder display column 61a on the user box screen 61, the folder named “document box 0” and then touches the open key 61f displayed on the user box screen 61, the display screen 55 so switches that a plurality of keys (unillustrated) marked with alphabetic and other characters, “A” to “Z” etc., to permit entry of a user ID and a password are displayed.

Then, when the user of the image forming apparatus 10 enters, via the display screen 55, a user ID and a password that coincide with the user ID and password associated with the folder named “document box 0”, the display screen 55 so switches that, as shown in FIG. 5, the document selection screen 71 that displays the contents of the folder named “document box 0” is displayed on the display screen 55.

Subsequently, the user of the image forming apparatus 10 selects one or more of the documents displayed in the document display column 71a on the document selection screen 71. Here, as shown in FIG. 5, on the document selection screen 71, if the user of the image forming apparatus 10 touches, for example, any of the parts where the name, updating date and time, and number of pages of, among the documents displayed in the document display column 71a, a document named “document 2”, then, among the documents displayed in the document display column 71a, the document named “document 2” is selected. Then, with respect to the document named “document 2”, the color of the characters displayed in the parts where the name, updating date and time, and number of pages of the document are displayed are inverted with the color of the background. Moreover, the check box 71c corresponding to this document is checked, and a number “001” is displayed on the left side of the check box 71c.

Thereafter, on the document selection screen 71, if the user of the image forming apparatus 10 touches, for example, any of the parts where the name, updating date and time, and number of pages of, among the documents displayed in the document display column 71a, a document named “document 0”, then, among the documents displayed in the document display column 71a, the document named “document 0” is selected. Then, the inverted display of the parts where the name, updating date and time, and number of pages of the document named “document 2” are displayed returns to normal display, and, with respect to the document named “document 0”, the color of the characters displayed in the parts where the name, updating date and time, and number of pages of the document are displayed are inverted with the color of the background. Moreover, the check box 71c corresponding to the document named “document 0” is checked, and a number “002” is displayed on the left side of the check box 71c (see FIG. 5).

After the user of the image forming apparatus has selected one or two or more documents among the documents displayed in the document display column 71a on the document selection screen 71 as described above, when the user touches the send key 71e displayed on the document selection screen 71, the display screen 55 so switches that the addressee setting screen 81 as shown in FIG. 6 is displayed on the display screen 55. Then, when the user of the image forming apparatus 10 selects an image data transmission addressee via the addressee setting screen 81, and the presses the start key 52 provided on the operation panel 50, the image data of the document selected by the user of the image forming apparatus 10 is read from the recording medium 18 to the memory 17.

Then, the telephone number of the image data transmission addressee selected via the addressee setting screen 81 by the user of the image forming apparatus 10 is dialed, and a dialing signal is transmitted to the facsimile apparatus 30 over the LAN 40 and the WAN 41 such as a telephone network. Subsequently, the image forming apparatus 10 communicates with the facsimile apparatus 30 to transmit the image data stored in the memory 17 to the facsimile apparatus 30 over the LAN 40 and the WAN 41 such as a telephone network.

When the image forming apparatus 10 communicates with the facsimile apparatus 30, if, as when the telephone line of the image data transmission addressee is busy, no communication can be established between the image forming apparatus 10 and the facsimile apparatus 30, the image data stored in the memory 17 is not transmitted from the image forming apparatus 10 to the facsimile apparatus 30. In this case, the counter provided in the control section 19 increments by one, making the count thereof equal to one. Moreover, based on the time kept by the timer provided in the control section 19, a predetermined time after the image data transmission addressee was dialed, it is dialed again so that a dialing signal is transmitted to the facsimile apparatus 30 over the LAN 40 and the WAN 41 such as a telephone network.

Thereafter, when the count of the counter provided in the control section 19 reaches a predetermined value (for example, three), that is, if no communication can be established between the image forming apparatus 10 and the facsimile apparatus 30 even after the telephone number of the image data transmission addressee is dialed a predetermined number of times (for example, three), a transmission error occurs. Thus, a message indicating a transmission error is displayed on the display screen 55 of the display section 15. Moreover, the image data stored in the memory 17 is, now in association with information about the name and the telephone number of the image data transmission addressee selected by the user of the image forming apparatus 10 and information indicating that a transmission error has occurred, moved to a folder provided in the document box on the recording medium 18 so as to be stored there.

Here, in a case where, with respect to the image data stored in the memory 17, a document saved in a folder in the document box is selected and the image data of this document is transmitted to a specified addressee, the image data stored in the memory 17 is returned to the folder in which the document is selected. Alternatively, here, in a case where, with respect to the image data stored in the memory 17, image data created by reading the image of an original document by the scanner function is transmitted to a specified addressee, the data table stored on the recording medium 18 and containing the correspondence between the numbers assigned to folders and the user IDs and passwords of users of the image forming apparatus 10 is referred to. Then, based on the user ID and password authenticated by the user authentication section 16 of the image forming apparatus 10, the image data stored in the memory 17 is saved in the corresponding folder.

When a user of the image forming apparatus 10 selects, in the document display column 71a on the document selection screen 71 shown in FIG. 5, a document to be transmitted to the facsimile apparatus 30, if the selected document is found to have a transmission error record, the print key 71d and the preview key 71j disappear from the document selection screen 71. Thus, with respect to a document having a transmission error record, no user of the image forming apparatus 10 can print it by the printer function or view the contents thereof.

When a user of the image forming apparatus 10 selects a document having a transmission error record in the document display column 71a on the document selection screen 71 shown in FIG. 5 and then touches the send key 71e displayed on the document selection screen 71, the display screen 55 so switches that the addressee setting screen 81 as shown in FIG. 6 is displayed on the display screen 55.

Here, as described previously, in a folder provided in the document box on the recording medium 18, the document having a transmission error record is stored along with information about the name and the telephone number of the addressee to which the document is addressed and information indicating that a transmission error has occurred. Thus, in the addressee display column 81c on the addressee setting screen 81 shown in FIG. 6, the name and the telephone number of the addressee to which the document having a transmission error record selected by the user of the image forming apparatus 10 is addressed and that is associated with this document are selected and displayed.

Then, when the user of the image forming apparatus 10 presses the start key 52 provided on the operation panel 50, the telephone number selected and displayed in the addressee display column 81c on the addressee setting screen 81 is dialed, and a dialing signal is transmitted to the facsimile apparatus 30 over the LAN 40 and the WAN 41 such as a telephone network.

As described above, with respect to a document having a transmission error record, a user of the image forming apparatus 10 can transmit the image data of the document only to an addressee stored on the recording medium 18 and associated with this document. Thus, in the addressee setting screen 81 as shown in FIG. 6, if a user of the image forming apparatus 10 operates to change the addressee to which the document having a transmission error record is addressed, the display in the addressee setting screen 81 remains in the state in which the name and the telephone number of the addressee with which the document is associated and to which the document is addressed are selected.

Now, with respect to an image processing system provided with the image forming apparatus 10 operating as described above, with reference to FIG. 2, a description will be given of the flow of operations performed before a user of the image forming apparatus 10 starts to use the facsimile function of the image forming apparatus 10. No detailed description will be repeated, however, of such parts as overlap the operation of the image forming apparatus 10 described above.

First, when a person who is going to use the image forming apparatus 10 enters a user ID and a password via the display screen 55 of the display section 15, information according to what is entered by the user is transmitted from the operation section 14 to the user authentication section 16. The user authentication section 16, by referring to the user IDs and passwords stored in the recording medium 18 as those of people registered as users of the image forming apparatus 10, checks whether or not the person who is going to use the image forming apparatus 10 is registered as a user of the image forming apparatus 10.

Through this checking, if the user authentication section 16 finds the person who has entered the user ID and password via the display screen 55 of the display section 15 to be one who is not registered as a user of the image forming apparatus 10, the user authentication section 16 transmits a control signal indicating this result to the control section 19. Then, on the display screen 55 of the display section 15, a message is displayed that indicates that user authentication has been unsuccessful. Thus, a person who is not registered on the recording medium 18 as a user of the image forming apparatus 10 cannot use the functions of the image forming apparatus 10.

On the other hand, through the above checking, if the user authentication section 16 finds the person who has entered the user ID and password via the display screen 55 of the display section 15 to be one who is registered as a user of the image forming apparatus 10, the user authentication section 16 transmits a control signal indicating this result to the control section 19. Then, on the display screen 55 of the display section 15, a message is displayed that indicates that user authentication has been successful.

When user authentication by the user authentication section 16 of the image forming apparatus 10 ends successfully, the user of the image forming apparatus 10 presses one of the function select keys 51 provided on the operation panel 50 shown in FIG. 3 to select the function that he or she wants to use among the copier, printer, scanner, and facsimile functions.

For example, when a user of the image forming apparatus 10 presses the function select key 51 assigned to the copier function, information according to what the user of the image forming apparatus 10 enters is transmitted from the operation section 14 to the control section 19. Then, when the control section 19 recognizes that the user of the image forming apparatus 10 has pressed the function select key 51 assigned to the copier function, the image forming apparatus 10 switches to the copier function.

Then, the image forming apparatus 10 prints an image on recording paper by sequentially going through the following processes: a reading process in which the image of an original document is read; a charging process in which the surface of a photoconductor drum (unillustrated) is electrically charged; an exposure process in which laser light is shone on the charged photoconductor drum to form an electrostatic latent image on the surface thereof; a developing process in which a toner is adhered to the electrostatic latent image formed on the surface of the photoconductor drum to develop the image; a transferring process in which the toner adhered on the surface of the photoconductor drum is transferred to recording paper; and a fixing process in which the toner transferred to the recording paper is fixed on the recording paper.

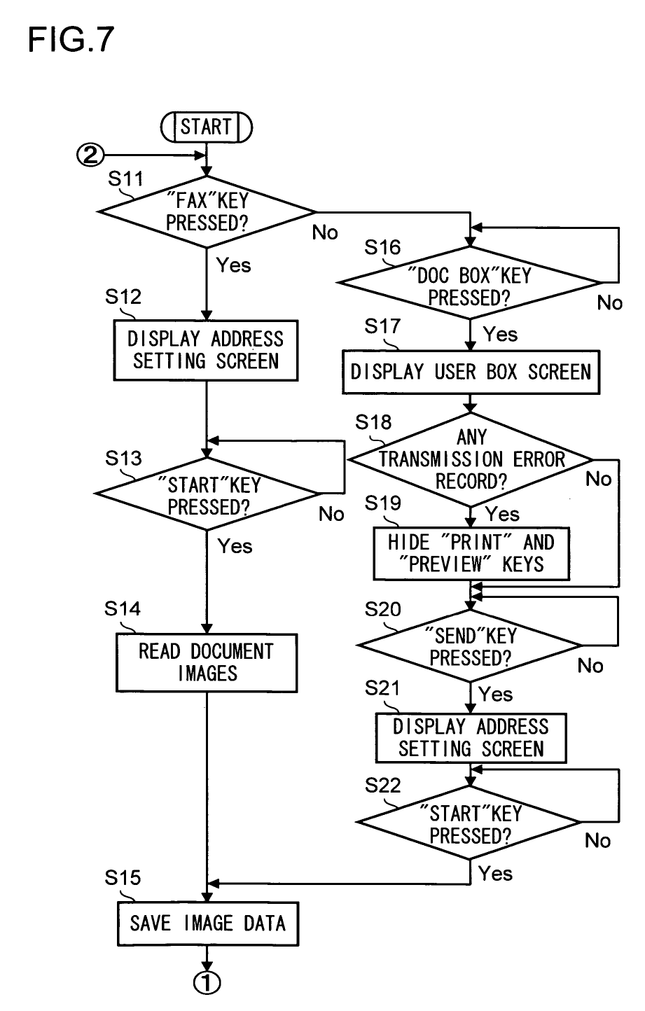

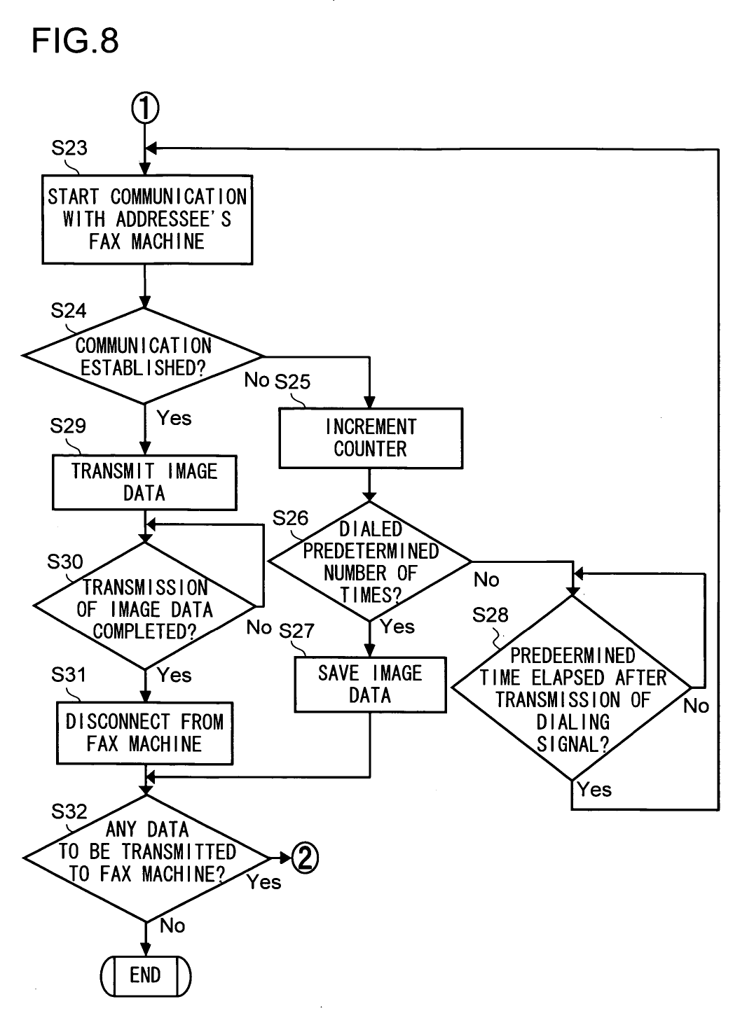

Now, with respect to an image processing system provided with the image forming apparatus 10 operating as described above, with reference to the flow charts shown in FIGS. 7 and 8, a description will be given of the flow of operations performed when a user of the image forming apparatus 10 uses the facsimile function of the image forming apparatus 10.

Here, as described previously, when a user of the image forming apparatus 10 transmits image data to a specified addressee, the user can choose between to transmit image data created by reading the image of an original document by the scanner function to a specified addressee and to select a document saved in a folder in the document box and transmit the image data of this document to a specified addressee.

Then, when the user of the image forming apparatus 10 presses, among the function select keys 51 provided on the operation panel 50, the function select key 51 assigned to the facsimile function, information according to what is entered by the user of the image forming apparatus 10 is transmitted from the operation section 14 to the control section 19. Subsequently, when the control section 19 recognizes that the user of the image forming apparatus 10 has pressed the function select key 51 assigned to the facsimile function (“Yes” in step S11), the image forming apparatus 10 switches to the facsimile function, and, on the display screen 55 of the display section 15, the addressee setting screen 81 for the setting of an image data transmission addressee is displayed (step S12, see FIG. 6).

Thereafter, when the user of the image forming apparatus 10 sets an image data transmission addressee via the addressee setting screen 81, and then presses the start key 52 provided on the operation panel 50, information according to what is entered by the user of the image forming apparatus 10 is transmitted from the operation section 14 to the control section 19. Then, when the control section 19 recognizes that the user of the image forming apparatus 10 has pressed the start key 52 (“Yes” in step S13), the original document is taken into the image forming apparatus 10 via the document feed inlet provided in the scanner section 13, and the image of the original document is read by the scanner function to create image data (step S14). Moreover, the control section 19 so instructs that the created image data is stored in the memory 17 (step S15).

On the other hand, in step S11, if the control section 19 cannot recognize that the user of the image forming apparatus 10 has pressed the function select key 51 assigned to the facsimile function (“No” in step S11), then subsequently the control section 19 checks whether or not the user of the image forming apparatus 10 has pressed the document box key 54 provided on the operation panel 50 (step S16).

Here, if the user of the image forming apparatus 10 has pressed the document box key 54 provided on the operation panel 50 so that the control section 19 recognizes that the user of the image forming apparatus 10 has pressed the document box key 54 (“Yes” in step S16), then, on the display screen 55 of the display section 15, the user box screen 61 that displays all the folders stored on the recording medium 18 is displayed (step S17, see FIG. 4).

When the user of the image forming apparatus 10 selects a folder via the user box screen 61 shown in FIG. 4, and then selects a document via the document selection screen 71 shown in FIG. 5, information according to what is entered by the user of the image forming apparatus 10 is transmitted from the operation section 14 to the control section 19. Subsequently, the control section 19 checks the document selected by the user of the image forming apparatus 10, and then, by referring to the information about the document as stored on the recording medium 18, checks whether or not the document selected by the user of the image forming apparatus 10 has a transmission error record (step S18).

Here, if the control section 19 finds the document selected by the user of the image forming apparatus 10 to have a transmission error record (“Yes” in step S18), the print key 71d and the preview key 71j disappears from the document selection screen 71 shown in FIG. 5 (step S19). On the other hand, if the control section 19 finds the document selected by the user of the image forming apparatus 10 to have no transmission error record (“No” in step S18), the print key 71d and the preview key 71j remain displayed on the document selection screen 71 shown in FIG. 5 (step S19).

Subsequently, when the user of the image forming apparatus 10 touches the send key 71e displayed on the document selection screen 71, information according to what is entered by the user of the image forming apparatus 10 is transmitted from the operation section 14 to the control section 19. Then, when the control section 19 recognizes that the user of the image forming apparatus 10 has touched the send key 71e (“Yes” in step S20), the image forming apparatus 10 switches to the facsimile function, and the addressee setting screen 81 for setting an image data transmission addressee is displayed on the display screen 55 of the display section 15 (step S21, see FIG. 6). Here, if the document selected by the user of the image forming apparatus 10 has a transmission error record, the name and the telephone number of an addressee that is associated with the document and to which to transmit the document are selected and displayed in the addressee display column 81c of the addressee setting screen 81.

Thereafter, when the user of the image forming apparatus 10 sets an image data transmission addressee via the addressee setting screen 81, and then presses the start key 52 provided on the operation panel 50, information according to what is entered by the user of the image forming apparatus 10 is transmitted from the operation section 14 to the control section 19. Then, when the control section 19 recognizes that the user of the image forming apparatus 10 has pressed the start key 52 (“Yes” in step S22), the control section 19 so instructs that the image data of the document selected by the user of the image forming apparatus 10 is extracted from the recording medium 18 and is stored in the memory 17 (step S15).

When, according to the instruction of the control section 19, the image data to be transmitted to the facsimile apparatus 30 is stored in the memory 17, the telephone number of the image data transmission addressee selected via the addressee setting screen 81 shown in FIG. 6 is dialed, and a dialing signal is transmitted from the transmission/reception section 11 to a facsimile apparatus 30 over the LAN 40 and the WAN 41 such as a telephone network (step S23, see FIG. 1).

Subsequently, the control section 19 checks whether or not communication is established between the image forming apparatus 10 and the facsimile apparatus 30 (step S24). Here, if the control section 19 recognizes that no communication is established between the image forming apparatus 10 and the facsimile apparatus 30 (“No” in step S24), the counter provided in the control section 19 increments by one (step S25), making the count thereof equal to one.

Then, the control section 19 checks whether or not the count of the counter has reached a predetermined value (for example, three), that is, whether or not the image data transmission addressee selected via the addressee setting screen 81 shown in FIG. 6 has been dialed a predetermined number of times (for example, three) (step S26).

Here, based on the count of the counter, if the control section 19 recognizes that the number of times that the image data transmission addressee selected via the addressee setting screen 81 shown in FIG. 6 has been dialed has reached the predetermined number (“Yes” in step S26), a transmission error occurs. Thus, the control section 19 transmits a control signal to the display section 15 so that a message indicating that a transmission error has occurred is displayed on the display screen 55 of the display section 15. Moreover, the control section 19 so instructs that the untransmitted image data is extracted from the memory 17 and is saved, in association with the name and the telephone number of the addressee to which the untransmitted image data is addressed, in a folder provided in the document box on the recording medium 18 (step S27).

Here, based on the count of the counter, if the control section 19 recognizes that the number of times that the image data transmission addressee selected via the addressee setting screen 81 shown in FIG. 6 has been dialed has not reached the predetermined number (“No” in step S26), then the control section 19 checks whether a predetermined time has elapsed since a dialing signal was transmitted to the image data transmission addressee selected via the addressee setting screen 81 shown in FIG. 6 (step S28).

Here, based on the count of the counter provided in the control section 19, if the control section 19 recognizes that the predetermined time has elapsed since a dialing signal was transmitted to the image data transmission addressee selected via the addressee setting screen 81 shown in FIG. 6 (“Yes” in step S28), the flow returns to step S23 so that the telephone number of the image data transmission addressee selected via the addressee setting screen 81 shown in FIG. 6 is dialed and a dialing signal is transmitted to a facsimile apparatus 30 over the LAN 40 and the WAN 41 such as a telephone network.

On the other hand, in step S24, if the control section 19 recognizes that communication is established between the image forming apparatus 10 and the facsimile apparatus 30 (“Yes” in step S24), image data is extracted from the memory 17, and the image data is transmitted to the facsimile apparatus 30 over the LAN 40 and the WAN 41 such as a telephone network.

Subsequently, the control section 19 checks whether or not the transmission of the image data from the transmission/reception section 11 of the image forming apparatus 10 to the facsimile apparatus 30 is completed (step S30). Here, if the control section 19 recognizes that the transmission of the image data from the transmission/reception section 11 of the image forming apparatus 10 to the facsimile apparatus 30 is not completed (“No” in step S30), the transmission of the image data from the transmission/reception section 11 of the image forming apparatus 10 to the facsimile apparatus 30 is continued. On the other hand, here, if the control section 19 recognizes that the transmission of the image data from the transmission/reception section 11 of the image forming apparatus 10 to the facsimile apparatus 30 is completed (“Yes” in step S30), the control section 19 so instructs that the communication between the transmission/reception section 11 of the image forming apparatus 10 and the facsimile apparatus 30 is stopped (step S31).

Then, after the communication between the transmission/reception section 11 of the image forming apparatus 10 and the facsimile apparatus 30 is stopped in step S31, or after the untransmitted image data is stored on the recording medium 18 in step S27, the control section 19 checks whether or not there is image data to be transmitted to the facsimile apparatus 30 next (step S32).

Here, if the control section 19 recognizes that there is image data to be transmitted to the facsimile apparatus 30 next (“Yes” in step S32), then the flow returns to step S1 so that the control section 19 checks whether the user of the image forming apparatus 10 has pressed the function select key 51 assigned to the facsimile function. On the other hand, here, if the control section 19 recognizes that there is no image data to be transmitted to the facsimile apparatus 30 next (“No” in step S32), the flow of operations concerned with the facsimile function ends.

In this embodiment, even when image data that has been left untransmitted due to a transmission error is stored in the document box on the recording medium 18, the image data so stored in the document box, which image data thus has a transmission error record, is inhibited from being displayed on the display screen 55 of the display section 15. Thus, it is possible to securely prevent leakage of information resulting from image data having a transmission error record being viewed via the display screen 55 of the display section 15. This helps enhance the degree of security provided by the image forming apparatus 10.

Moreover, in this embodiment, of all the image data stored in the document box on the recording medium 18, image data having a transmission error record is inhibited from being printed by the image formation section 12 by the printer function. This securely prevents an important document such as a confidential document from being printed by the image formation section 12 and thereby made viewable. This helps further enhance the degree of security provided by the image forming apparatus 10.

Moreover, in this embodiment, when image data cannot be transmitted to an addressee specified via the addressee setting screen 81 by a user, the image data left untransmitted is stored, in association with the name and the telephone number of that image data transmission addressee, in the document box on the recording medium 18. Then, when an instruction to transmit the untransmitted image data thus stored in the document box on the recording medium 18 is given, the image data can be transmitted only to the specified addressee. Thus, the image data is inhibited from being transmitted to other than the specified addressee. In this way, it is possible to prevent image data from being transmitted to other than a specified addressee, and thus it is possible to securely prevent an important document such as a confidential document from being erroneously, intentionally, or otherwise transmitted to an addressee other than a specified addressee. This helps further enhance the degree of security provided by the image forming apparatus 10.

In the image processing system described above, the result of checking whether the transmission of image data from the transmission/reception section 11 of the image forming apparatus 10 to the facsimile apparatus 30 has been successful or not may be transmitted, by using the mailing function of the image forming apparatus 10, from the transmission/reception section 11 of the image forming apparatus 10 to each of the terminal apparatuses 20 that are connected to the image forming apparatus 10 over the LAN 40. In this case, the mail message transmitted from the transmission/reception section 11 of the image forming apparatus 10 to each terminal apparatus 20 may contain, in addition to the above-mentioned result of the transmission of image data, part or all of the image data (for example, the first page of the image data) in the form of an attached file.

Alternatively, in the image processing system described above, the result of checking whether the transmission of image data from the transmission/reception section 11 of the image forming apparatus 10 to the facsimile apparatus 30 has been successful or not may be printed on recording paper by the printer function of the image forming apparatus 10. In this case, in addition to the above-mentioned result of the transmission of image data, part or all of the image data (for example, the first page of the image data) may also be printed on the recording paper.

In the image processing system described above, when image data cannot be transmitted from the transmission/reception section 11 of the image forming apparatus 10 to the facsimile apparatus 30 and a transmission error occurs, the telephone number of the addressee to which the image data is addressed cannot be changed. This, however, may be otherwise. Specifically, before image data is transmitted from the transmission/reception section 11 of the image forming apparatus 10 to the facsimile apparatus 30, a user of the image forming apparatus 10 may tag the image data with an indication of its importance so that, when the image data fails to be transmitted from the transmission/reception section 11 of the image forming apparatus 10 to the facsimile apparatus 30 and a transmission error occurs, the telephone number of the addressee to which the image data is addressed cannot be changed only if the importance of the image data is high.

What is claimed is:

1. An image forming apparatus comprising:
a storage section that stores image data;
a display section that displays said image data stored in said storage section;
a transmission section that extracts from said storage section said image data stored therein and then transmits said image data; and
a control section that, when a transmission error occurs while said transmission section is transmitting said image data and said transmission section can no longer transmit said image data, stores in said storage section said image data left untransmitted as said image data having a transmission failure record, and inhibits output of, of said image data stored in said storage section, said image data having the transmission failure record.

2. The image forming apparatus of claim 1,
wherein said control section inhibits display on said display section of, of said image data stored in said storage section, said image data having the transmission failure record.

3. The image forming apparatus of claim 1, further comprising:
a printout section that prints out said image data stored in said storage section,
wherein said control section inhibits printing-out by said printout section of, of said image data stored in said storage section, said image data having the transmission failure record.

4. The image forming apparatus of claim 1, further comprising:
an image reading section that creates said image data by reading an image of an original document,
wherein said control section stores in said storage section said image data created by said image reading section reading the image of the original document.

5. The image forming apparatus of claim 1,
wherein, when a transmission error occurs while said transmission section is transmitting said image data to a specified addressee and said transmission section can no longer transmit said image data to the specified addressee, said control section stores in said storage section said image data left untransmitted in association with information of the addressee to which said image data is addressed, and,
when transmission of said image data stored in said storage section and having a transmission failure record is requested, said control section permits transmission of said image data only to the addressee stored in said storage section in association with said image data having the transmission failure record.

6. The image forming apparatus of claim 1, further comprising:
a user authentication section that authenticates a user by being fed with a user ID; and
a storage region that is allocated one to each user in said storage section in association with an user ID assigned one for each user,
wherein said control section displays on said display section said image data saved in said storage region as corresponding to the user authenticated by said user authentication section, and
wherein, when a transmission error occurs while said transmission section is transmitting said image data and said transmission section can no longer transmit said image data, said control section saves said image data left untransmitted in said storage region corresponding to the user ID authenticated by said user authentication section.
